(19) United States
(12) Patent Application Publication
(10) Pub. No.: US 2022/0194410 A1
(43) Pub. Date: Jun. 23, 2022

(54) METHOD OF GENERATING VIRTUAL EFFECT FOR ELECTRIC VEHICLE

(71) Applicants: Hyundai Motor Company, Seoul (KR); Kia Corporation, Seoul (KR)

(72) Inventors: Ki Chang Kim, Suwon (KR); Tae Kun Yun, Anyang (KR); Dong Chul Park, Anyang (KR)

(21) Appl. No.: 17/380,553

(22) Filed: Jul. 20, 2021

(30) Foreign Application Priority Data
Dec. 21, 2020 (KR) 10-2020-0179387

(51) Int. Cl. B60W 50/16; B60W 20/20; B60W 20/40

(52) U.S. Cl. CPC B60W 50/16; B60W 20/20; B60W 2540/10; B60W 2510/083; B60W 2510/081; B60W 20/40

(57) ABSTRACT

A method of generating a virtual effect for an electric vehicle. The method includes collecting, by a controller, vehicle driving information for generating the virtual effect during driving of the electric vehicle; and determining, by the controller, a characteristic of the virtual effect based on the collected vehicle driving information. A virtual effect is generated by a virtual effect producing signal for producing the determined characteristic of the virtual effect; and operating, by the virtual effect producing signal generated by the controller, a vibration actuator placed in a seat of the electric vehicle. Accordingly the vibration actuator produces vibration according to the determined characteristic of the virtual effect and a driver or a passenger who is in the seat experiences the vibration.

### CROSS REFERENCE TO RELATED APPLICATION

The present application claims priority to Korean Patent Application No. 10-2020-0179387, filed Dec. 21, 2020, the entire contents of which is incorporated herein for all purposes by this reference.

### BACKGROUND

### Field of the Disclosure

The present disclosure relates to a method of generating a virtual effect for an electric vehicle, and more particularly, to a method of generating a virtual effect for an electric vehicle in which virtual sound and virtual vibration are produced and provided together, wherein the virtual sound simulates sound that comes from a non-electric vehicle, such as an internal combustion engine vehicle, and the virtual vibration simulates sensations of acceleration and deceleration, vibration during driving, shift shock, etc. of the non-electric vehicle.

### Description of the Related Art

As is well known, an electric vehicle (EV) is a vehicle that operates using a motor. A powertrain of the electric vehicle includes: a battery that supplies electric power for driving the motor; an inverter connected to the battery and that operates the motor; the motor, which is a vehicle driving source, connected to the battery via the inverter for charging and discharging; and a reducer that reduces torque of the motor for transmission to driving wheels.

Herein, in driving of the motor, the inverter changes direct current (DC) supplied from the battery to alternating current (AC) and applies the alternating current to the motor through a power cable. In regenerative braking of the motor, the inverter changes alternating current generated from the motor to direct current and supplies the direct current to the battery to charge the battery.

Unlike a conventional internal combustion engine vehicle, a general electric vehicle does not use a multi-speed transmission, but instead, a reducer using a fixed gear ratio is disposed between the motor and the driving wheel. This is because unlike the internal combustion engine that has a wide range of energy efficiency distribution depending on an operating point and is able to provide a high torque only in a high-speed region, the motor has a relatively small difference in efficiency for an operating point and is able to achieve a low-speed high-torque only with the characteristics of the motor alone.

In addition, a vehicle equipped with the conventional internal combustion engine powertrain requires a starting mechanism, such as a torque converter or a clutch, because of the characteristics of the internal combustion engine that is incapable of low-speed driving. In the powertrain of the electric vehicle, however, the motor thereof has the characteristics of easy low-speed driving, so that the starting mechanism is not provided. Due to the characteristics of the powertrain of the electric vehicle, an inherent vibration feature caused by a torsional damper, a dual mass flywheel, etc. used in the powertrain of the internal combustion engine vehicle does not occur.

The mechanical differences enable the electric vehicle to provide a smooth driving experience without interruption caused by shifting, unlike the internal combustion engine vehicle. While the powertrain of the conventional internal combustion engine vehicle creates power by burning fuel, the powertrain of the electric vehicle creates power by driving the motor with the electric power of the battery. Therefore, unlike the torque of the internal combustion engine, the torque of the electric vehicle is substantially precise, smooth and has a rapid response.

Such characteristics of the electric vehicle are regarded as positive, but the absence of an internal combustion engine, a transmission, a clutch, etc. may bore a driver who wants to enjoy driving. In the case of a high-performance vehicle, various effects caused by noises, physical vibration, and thermodynamical actions of an internal combustion engine may be important for sentiment. No vibration during driving of the electric vehicle is certainly an advantage since no vibration enables a soft and smooth driving experience. Nevertheless, depending on driver's disposition or a sporty character of a vehicle, it is required to arouse sentiment with vibration for enjoyable driving.

Accordingly, there is a need for a technology that enables a driver of an electric vehicle, in which an internal combustion engine, a transmission, a clutch, etc. are not provided, to experience sensations of acceleration and deceleration, vibration during driving, shift shock, etc., which may be felt in an internal combustion engine vehicle, through vibration. In addition, there is a need for a technology for producing virtual vibration in conjunction with virtual sound in an electric vehicle.

The foregoing is intended merely to aid in the understanding of the background of the present disclosure, and is not intended to mean that the present disclosure falls within the purview of the related art that is already known to those skilled in the art.

### SUMMARY

The present disclosure is directed to providing a method of generating a virtual effect for an electric vehicle in which virtual vibration is produced and provided, the virtual vibration simulating sensations of acceleration and deceleration, vibration during driving, shift shock, etc. of an internal combustion engine vehicle. In addition, the present disclosure is directed to providing a method of generating a virtual effect for an electric vehicle in which virtual vibration in conjunction with virtual sound is produced.

Purposes of the present disclosure will not be limited to the above-described purposes, and other purposes that are not described herein will become apparent to a person (hereinafter, referred to as “those skilled in the art”) with an ordinary skill in the art to which the present disclosure pertains from the following description.

According to an embodiment of the present disclosure, a method of generating a virtual effect for an electric vehicle may include: collecting, by a controller, vehicle driving information for generating the virtual effect during driving of the electric vehicle; determining, by the controller, a characteristic of the virtual effect based on the collected vehicle driving information; generating, by the controller, a virtual effect producing signal for producing the determined characteristic of the virtual effect; and operating, by the virtual effect producing signal generated by the controller, a vibration actuator placed in a seat of the electric vehicle such that the vibration actuator produces vibration according to the determined characteristic of the virtual effect and a driver or a passenger who is in the seat experiences the vibration.

Herein, the vehicle driving information may include one among a driver accelerator pedal input value detected by an accelerator pedal detector, a vehicle powertrain speed detected by a speed detector, and a vehicle speed detected by a vehicle speed detector. In addition, the vehicle powertrain speed may be one among a rotational speed of a vehicle driving motor, a rotational speed of a driving wheel, and a rotational speed of a drive shaft. In addition, in an exemplary embodiment of the present disclosure, the controller may be configured to determine the characteristic of the virtual effect from a torque command of a vehicle driving motor acquired by the collected vehicle driving information.

In addition, in the exemplary embodiment the present disclosure, the characteristic of the virtual effect may include at least one among an amount, an amplitude, a period, and a frequency band of the vibration to be produced by the vibration actuator. The vehicle driving information may include one among a driver accelerator pedal input value detected by an accelerator pedal detector, a vehicle powertrain speed detected by a speed detector, and a vehicle speed detected by a vehicle speed detector, and the controller may be configured to determine the amount of the vibration to be a value that is proportional to the driver accelerator pedal input value, the vehicle powertrain speed, or the vehicle speed.

The method of generating the virtual effect for the electric vehicle may further include: operating, by the virtual effect producing signal generated by the controller, a sound device provided at the electric vehicle such that the sound device produces virtual sound according to the determined characteristic of the virtual effect. Herein, the virtual sound may be virtual post-combustion sound simulating post-combustion sound coming from an exhaust system of an internal combustion engine vehicle, virtual engine sound simulating engine sound coming from an engine of the internal combustion engine vehicle, or virtual motor sound that is imagined coming from a vehicle driving motor.

In addition, in an exemplary embodiment of the present disclosure, the characteristic of the virtual effect for producing the virtual sound may include a starting point in time at which the virtual sound is output through the sound device, and may further include at least one among a strength, duration, a time interval of the virtual sound, and a frequency band or a pitch that is how high or low a sound is. The virtual effect may be the virtual sound and virtual vibration, and the controller may be configured to, determine a characteristic of the virtual sound for producing the virtual sound, determine, from the determined characteristic of the virtual sound, a characteristic of the virtual vibration for producing the virtual vibration, and generate the virtual effect producing signal according to the determined characteristic of the virtual sound and the determined characteristic of the virtual vibration, so that the vibration actuator produces the virtual vibration and the sound device produces the virtual sound simultaneously according to the generated virtual effect producing signal.

Further, when the virtual sound is produced in an interior of the electric vehicle through the sound device, the produced virtual sound is sensed using a sensor, and the controller may be configured to convert a signal of the sensed virtual sound into a signal of vibration, and the controller may be configured to use the signal of vibration resulting from conversion as the virtual effect producing signal for producing virtual vibration so that the vibration actuator produces the virtual vibration. In addition, in an exemplary embodiment of the present disclosure, the controller may be configured to synthesize a signal of the virtual sound of a left channel and a signal of the virtual sound of a right channel that are sensed by the respective sensors after output from the sound device, and convert the synthesized signals of the virtual sound into the signal of vibration.

The controller may be configured to operate a filter to filter the signal of the sensed virtual sound such that from the signal of the sensed virtual sound, a frequency band corresponding to a low tone or a high tone is selected or a determined frequency band is selected, and the controller may be configured to convert the resulting signal into the signal of vibration. The controller may be configured to perform envelope processing on the filtered signal of the virtual sound and convert the resulting signal into the signal of vibration.

According to the method of generating the virtual effect for the electric vehicle according to the present disclosure, the virtual vibration and the virtual sound may be produced and provided together in the electric vehicle, wherein the virtual sound simulates sound coming from a non-electric vehicle, such as an internal combustion engine vehicle, and the virtual sound simulates sensations of acceleration and deceleration, vibration during driving, shift shock, etc. of the non-electric vehicle. In addition, the virtual vibration in conjunction with the virtual sound may be produced in the electric vehicle.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1A is a diagram schematically showing positions of vibration actuators placed in a seat, in a method of generating a virtual effect according to an exemplary embodiment of the present disclosure;

FIG. 1B is a diagram showing several examples differing in the number and positions of vibration actuators, in a method of generating a virtual effect according to an exemplary embodiment of the present disclosure;

FIG. 2 is a perspective view showing an example of a vibration actuator available in a method of generating a virtual effect according to an exemplary embodiment of the present disclosure;

FIG. 3 is a block diagram showing a configuration of an apparatus for performing a virtual effect generation process according to an exemplary embodiment of the present disclosure;

FIGS. 4 and 5 are diagrams showing examples of controlling virtual vibration and virtual sound according to an exemplary embodiment of the present disclosure; and

FIG. 6 is a flowchart showing a process of producing virtual vibration by processing a signal of sensed virtual sound in a method of generating a virtual effect according to an exemplary embodiment of the present disclosure.

### DETAILED DESCRIPTION

Specific structural and functional descriptions of exemplary embodiments of the present disclosure are only for illustrative purposes of the embodiments according to the present disclosure, and the embodiments according to the present disclosure may be implemented in various forms. Further, the present disclosure should not be construed as being limited to the following embodiments, but should be construed as including all changes, equivalents, and replacements included in the spirit and the scope of the present disclosure.

In the meantime, terms “first”, “second”, etc. used in the present disclosure can be used to describe various elements, but the elements are not to be construed as being limited to the terms. These terms are only used to distinguish one element from another element. For instance, a first element could be termed a second element without departing from the scope of the present disclosure. Similarly, the second element could also be termed the first element.

It will be understood that when an element is referred to as being “coupled” or “connected” to another element, the former can be directly coupled or connected to the latter or intervening elements may be present therebetween. In contrast, it will be understood that when an element is referred to as being “directly coupled” or “directly connected” to another element, there are no intervening elements present. Other words used to describe the relationship between elements, such as “between”, “directly between”, “adjacent”, “directly adjacent”, etc., should be construed in the same way.

Throughout the specification, the same reference numerals refer to the same elements. The terms used herein are provided to describe the embodiments but not to limit the present disclosure. In the specification, the singular forms include plural forms unless particularly mentioned. The terms “comprises” and/or “comprising” used herein specify the presence of stated constituents, steps, operations, and/or elements, but do not preclude the presence or addition of one or more other constituents, steps, operations, and/or elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings. The present disclosure is directed to providing a method of producing and generating a virtual effect for an electric vehicle, the virtual effect simulating sound and vibration occurring in a non-electric vehicle, such as an internal combustion engine vehicle. Herein, the non-electric vehicle refers to a vehicle of a type other than an electric vehicle. More specifically, the non-electric vehicle refers to a vehicle equipped with a powertrain different from a powertrain of an electric vehicle.

For example, the non-electric vehicle is an internal combustion engine vehicle equipped with an internal combustion engine powertrain. In the following description, an internal combustion engine and an engine are used as having the same meaning, which is a technical detail easily understood by those skilled in the art. In the present disclosure, the virtual effect may be virtual sound and virtual vibration. More specifically, in the present disclosure, the virtual effect does not actually occur in a known electric vehicle, and may refer to virtual sound and virtual vibration that simulate sound and vibration occurring in a non-electric vehicle, such as an internal combustion engine vehicle.

In the present disclosure, the virtual sound and the virtual vibration are produced through a sound device and a vibration actuator, respectively, provided in the electric vehicle. It is be clarified that the virtual sound and the virtual vibration are virtual effects simulating sound and vibration of a non-electric vehicle, and are actually produced through the sound device and the vibration actuator, respectively, so that a driver or a passenger is able to actually experience the sound and the vibration in an electric vehicle to which the present disclosure applies.

An apparatus for generating a virtual effect that performs a virtual effect generation process according to the present disclosure may include: a sound device producing and outputting the virtual sound; and a vibration actuator producing the virtual vibration. The vibration actuator may be configured to produce and provide, in an electric vehicle, the virtual vibration that simulates sensations of acceleration and deceleration, vibration during driving, shift shock, etc. of a non-electric vehicle, such as an internal combustion engine vehicle, etc. Further, as will be described later, the vibration actuator may be configured to produce and provide the virtual vibration in conjunction with the virtual sound.

In the present disclosure, the vibration actuator may be disposed in a seat of a vehicle. Herein, the seat may be any seat within a vehicle, including a driver seat, a front passenger seat, a rear seat, etc. In the present disclosure, the vibration actuator disposed in the seat operates according to a virtual effect producing signal generated from a controller (a first controller described later) and produces vibration. In other words, in the present disclosure, the controller may be configured to operate the vibration actuator by generating the virtual effect producing signal for producing desired vibration. Thus, sitting on the seat, the driver or the passenger is able to physically feel the vibration produced by the vibration actuator.

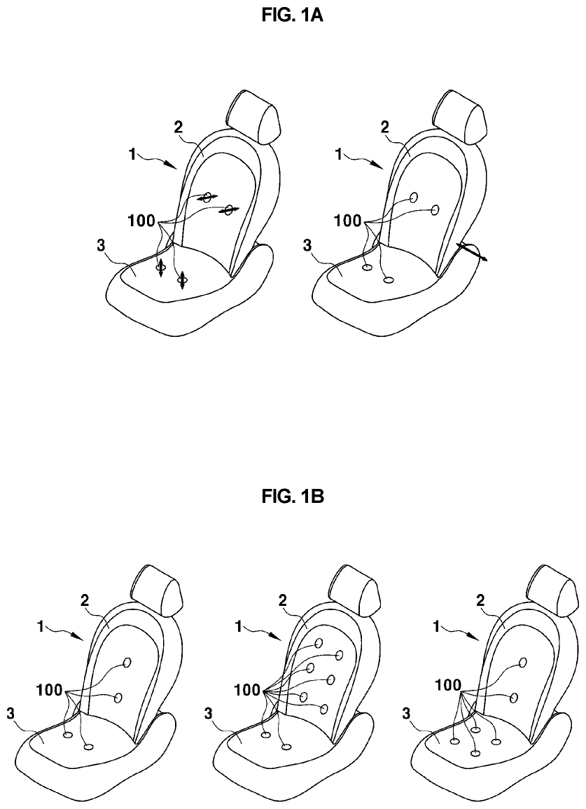

Hereinafter, in describing an exemplary embodiment of the present disclosure, a vibration actuator placed in a seat will be described first in detail. FIG. 1A is a diagram schematically showing positions of vibration actuators disposed in a seat, in a method of generating a virtual effect according to an exemplary embodiment of the present disclosure. In addition, FIG. 1B is a diagram showing several examples differing in the number and positions of vibration actuators, in an apparatus for generating a virtual effect according to an exemplary embodiment of the present disclosure.

As described above, according to the exemplary embodiment of the present disclosure, the apparatus for generating the virtual effect may include a vibration actuator 100 embedded in a seat 1, as an element configured to product vibration in an electric vehicle like in an internal combustion engine vehicle. Herein, according to the exemplary embodiment of the present disclosure, the apparatus for generating the virtual effect for the electric vehicle may include multiple vibration actuators 100 embedded in the seat 1.

Herein, as shown in FIG. 1A, a determined number of vibration actuators 100 may be disposed in a backrest 2 and a seat base 3 of the seat 1 of the vehicle. FIG. 1A shows that two vibration actuators 100 are disposed in the backrest 2 and the seat base 3 each. The number of vibration actuators 100 is for illustrative purposes and the present disclosure is not limited thereby. The numbers or positions of the vibration actuators 100 disposed in the seat 10 may vary as shown in the examples of FIG. 1B.

The left figure of FIG. 1A shows an example in which the vibration actuators 100 are disposed such that the vibration actuators 100 disposed in the backrest 2 produce vibration in a forward-backward (e.g., horizontal) direction (see the arrows) with respect to a vehicle body direction and the vibration actuators placed in the seat base 3 produce vibration in an upward-downward (e.g., vertical) direction (see the arrows) with respect to the vehicle body direction. In addition, the right figure of FIG. 1A shows an example in which the vibration actuators 100 are disposed such that all the vibration actuators 100 disposed in the backrest 2 and the seat base 3 produce vibration in a left-right direction (see the arrows) with respect to the vehicle body direction.

In an exemplary embodiment of the present disclosure, the virtual vibration simulating shift shock may be produced. Accordingly, when there is a request for shifting according to control logic of the controller for forming virtual shift shock, the controller is configured to generate a virtual effect producing signal for producing and generating the virtual effect. Herein, by the virtual effect producing signal generated from the controller, the vibration actuators 100 inside the seat 1 operate and produce vibration, so that the electric vehicle is able to produce vibration shock occurring when shifting is performed in a transmission of an internal combustion engine vehicle.

In addition, when the electric vehicle drives at constant speed or accelerates, the controller may be configured to determine the volume of the virtual sound based on an accelerator pedal input value (APS value) of the driver, a motor torque command, or a powertrain speed, and determines the amount of vibration and exciting force of vibration to be produced through the vibration actuators.

Hereinafter, a configuration of a vibration actuator that may be used in an apparatus for generating a virtual effect for an electric vehicle according to an exemplary embodiment of the present disclosure will be described in detail with reference to the following figure.

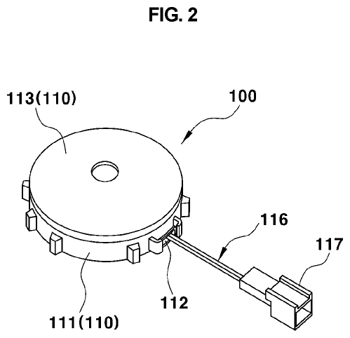

FIG. 2 is a perspective view showing an example of a vibration actuator available in a method of generating a virtual effect according to an exemplary embodiment of the present disclosure. In the method of generating the virtual effect for the electric vehicle according to the exemplary embodiment of the present disclosure, the vibration actuators 100 may be disposed in the backrest 2 and the seat base 3 as described above (see FIGS. 1A and 1B). Further, the vibration actuators 100 may be disposed inside respective foam pads of the backrest 2 and the seat base 3. As described above, in the case in which the vibration actuators 100 are disposed inside the foam pads of the seat 1, when the vibration actuators 100 operate, the driver or the passenger who is in the seat physically feels vibration produced by the vibration actuators.

In the present disclosure, each vibration actuator 100 may be connected to a drive circuit unit, not shown, via a terminal 112 of a casing 110 and a wire assembly 116 connected to the terminal 112. Thus, when an electrical signal (actuator driving current) for producing vibration is applied through the drive circuit unit inside or outside the controller according to the virtual effect producing signal generated by the controller (the first controller described later), the electrical signal is input from the drive circuit unit to the vibration actuator 100 via the wire assembly 116. Regarding the vibration actuator 100, the casing 110 may include a first casing 111 and a second casing 113 that are assembled to each other to form an airtight inner space.

In other words, operation of the vibration actuators 100 may be executed according to the electrical signal so that the vibration actuators produce desired vibration. Herein, the electrical signal may be an actuator driving current operated according to the virtual effect producing signal, and the current adjusted by the controller may be applied to the vibration actuators 100, so that the vibration actuators produce desired vibration.

In the meantime, in the method of generating the virtual effect according to the present disclosure, virtual vibration in conjunction with virtual sound may be produced by the controller and the vibration actuators. Accordingly, the controller may be configured to determine the characteristics of the virtual effect based on vehicle driving information and generate a virtual effect producing signal based on information on the determined characteristics of the virtual effect. In addition, the controller may be configured to adjust the sound device according to the generated virtual effect producing signal so that the sound device outputs virtual sound, and simultaneously adjust operation of the vibration actuators based on the virtual effect producing signal so that the vibration actuators produce and output desired virtual vibration.

In the present disclosure, the virtual sound produced and output by the sound device and the virtual vibration artificially produced by the vibration actuators may be sound and vibration that are produced in the electric vehicle according to vehicle driving states, and may be virtual sound and vibration simulating sound and vibration from a vehicle, for example, an internal combustion engine vehicle, of which the powertrain is different from that of a vehicle to which the present disclosure applies.

In the present disclosure, the virtual sound may be motor sound coming from a motor that is a driving device (power machine) of an electric vehicle during driving of the electric vehicle. Herein, the motor sound is virtual motor sound that is not actual sound of the motor, and is virtual driving sound of the motor that is imagined coming from the motor depending on driving conditions during driving of the electric vehicle.

Alternatively, in the present disclosure, the virtual sound may be virtual engine sound that simulates the engine sound coming from an engine during driving which is a driving device (power machine) of a powertrain, for example, an internal combustion engine vehicle powertrain, other than an electric vehicle powertrain. Since an electric vehicle does not have an engine, the virtual engine sound is not actual sound coming from the electric vehicle, but virtual sound. Further, the virtual engine sound is virtual driving sound of an engine that is imagined coming from the electric vehicle depending on driving conditions during driving of the electric vehicle.

In addition, in the present disclosure, the virtual vibration produced corresponding to the vehicle driving information may simulate engine vibration or vehicle vibration, or may simulate shift shock. In other words, the virtual vibration produced and realized in the present disclosure may be virtual vibration simulating driving vibration that occurs while an internal combustion engine vehicle drives at constant speed, accelerates, or decelerates, or may be vibration simulating shift shock of an internal combustion engine vehicle.

For example, when the control logic of the controller for realizing a virtual shifting function generates a shifting signal, the vibration actuators are operated to produce vibration for producing shift shock. Alternatively, the vibration produced and realized in the present disclosure may simulate the vibration caused by post combustion in an internal combustion engine vehicle. In addition, in the present disclosure, an actual vehicle driving condition, that is, the vehicle driving information, of the electric vehicle used in generating the virtual effect producing signal may be an accelerator pedal input value of the driver, a motor torque command, a powertrain speed, or the like. Alternatively, the vehicle driving information used in generating the virtual effect producing signal may be a vehicle speed.

Among virtual sounds, the virtual driving sound, that is, the virtual motor sound or the virtual engine sound, may be classified into acceleration driving sound, constant-speed driving sound, and deceleration driving sound according to working an accelerator pedal by the driver. It may be set to output the acceleration driving sound when the accelerator pedal is engaged for operation, or to output the constant-speed driving sound or the deceleration driving sound when the pressure of the accelerator pedal is released (e.g., pedal is disengaged).

The powertrain speed is a rotational speed of a vehicle powertrain component sensed by a sensor, and may be a rotational speed (motor speed) of a driving motor, a rotational speed (driving wheel speed) of a driving wheel, or a rotational speed (drive shaft speed) of a drive shaft. Alternatively, as powertrain speed information, a virtual engine speed that is a virtual variable may be used. The virtual engine speed may be calculated by the controller at a variable multiple value of the powertrain speed sensed by a sensor. Herein, the powertrain speed sensed by the sensor may be a motor speed. Herein, a value of a coefficient multiplied by the motor speed to calculate the virtual engine speed may be a value determined depending on a virtual transmission, its gear ratio model, and a virtual current gear position.

In addition, there is known a control method of producing virtual shift shock for an electric vehicle so as to produce and realize a multi-speed shift shock by controlling torque of a driving motor in an electric vehicle having no multi-speed transmission. In addition, it is known that in a control process for producing virtual shift shock for an electric vehicle, a virtual engine speed is used as one of virtual variables required for producing and realizing a multi-speed shift shock.

The virtual engine speed that is one of virtual variables used to produce and realize a multi-speed shift shock as described above may be used as a virtual variable for outputting the virtual sound in the present disclosure. In an exemplary embodiment of the present disclosure, the controller (the first controller described later) may be configured to determine a virtual engine speed using a virtual vehicle speed and gear ratio information of a virtual current gear position.

Herein, by using an actual motor speed that is one piece of actual variable (input variable) information and a virtual final-reduction gear ratio, the virtual vehicle speed may be calculated as a value that is in direct proportion to the actual motor speed. Herein, the virtual final-reduction gear ratio may be a value preset in the controller. In an exemplary embodiment of the present disclosure, a virtual vehicle speed may be calculated using the actual motor speed measured during driving of the electric vehicle and the virtual final-reduction gear ratio, and a virtual engine speed may be calculated in real time by the virtual vehicle speed.

In addition, the virtual engine speed may be acquired from the product of the virtual vehicle speed and a virtual gear ratio of the virtual current gear position. Alternatively, the virtual engine speed may be acquired from the product of the powertrain speed, such as the motor speed, etc., and the virtual gear ratio of the virtual current gear position. The virtual current gear position may be determined depending on a shift schedule map preset in the controller from a virtual vehicle speed and an accelerator pedal input value (APS value). Herein, instead of the virtual vehicle speed, an actual vehicle speed may be used. When the virtual current gear position is determined as described above, a virtual gear ratio corresponding to the gear position and a virtual vehicle speed or a motor speed are used to calculate a virtual engine speed in real time.

When the virtual current gear position is determined from the virtual vehicle speed and the accelerator pedal input value as described above, a virtual engine speed may be calculated based on information on the determined virtual current gear position. Herein, based on information on the acquired virtual engine speed, virtual sound may be produced in the electric vehicle. As described above, gear position information determined from the virtual vehicle speed and the accelerator pedal input value may be used, but instead of the gear position, a gear position selected when the driver shifts gears with a shift control means, such as a shift lever, may be used in producing virtual sound.

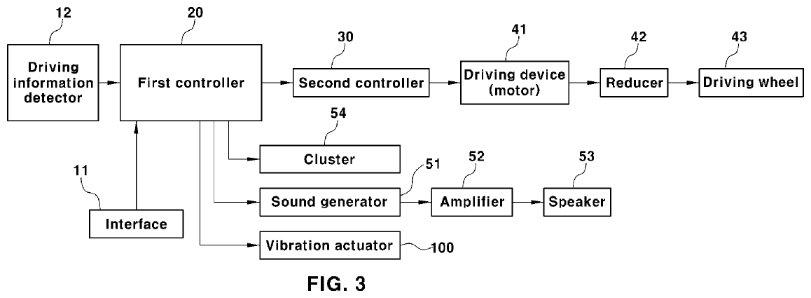

FIG. 3 is a block diagram showing a configuration of an apparatus for performing a virtual effect generation process according to an exemplary embodiment of the present disclosure. As shown in the figure, according to the exemplary embodiment of the present disclosure, the apparatus for performing the virtual effect generation process may include a driving information detector 12, a first controller 20, and at least one vibration actuator 100. The driving information detector 12 may be configured to detect vehicle driving information. The first controller 20 may be configured to determine, based on the vehicle driving information detected by the driving information detector 12, characteristics of a virtual effect while an electric vehicle drives, and then generate and output a virtual effect producing signal for producing the virtual effect according to the determined characteristics of the virtual effect. The at least one vibration actuator 100 operates to produce the virtual vibration according to the virtual effect producing signal output from the first controller 20.

Further, the apparatus may include a sound device operating to produce and output the virtual sound according to the virtual effect producing signal output from the first controller 20. Herein, the sound device may include a sound generator 51, an amplifier 52, and a speaker 53. The sound generator 51 may be configured to process a sound source signal and the virtual effect producing signal to generate and output a sound signal for producing the virtual sound. The amplifier 52 and the speaker 53, such as a woofer, etc., operate according to the sound signal and output the virtual sound. The speaker 53 may be disposed in the interior of the electric vehicle or the exterior thereof or both. Preferably, multiple speakers 53 may be disposed at the electric vehicle and used for outputting the virtual sound.

In addition, in the present disclosure, the first controller 20 may be configured to generate and output a torque command based on the vehicle driving information. A second controller 30 may be configured to operate a driving device 41 according to the torque command output from the first controller 20. The first controller 20 and the second controller 30 are controllers that are involved in a control process for producing the virtual sound and the virtual vibration in the electric vehicle and in a process of controlling driving of the electric vehicle.

In the following description, controllers are described distinguishing between the first controller 20 and the second controller 30, but the control process for producing the virtual sound and the virtual vibration and the process of controlling driving according to the present disclosure may be performed by a single integrated control element instead of the multiple controllers. The multiple controllers and the single integrated control element may be collectively referred to as a controller, and such a controller may be configured to perform a control process for outputting the virtual sound and producing the virtual vibration of the present disclosure described below. Herein, the controller may collectively refer to both the first controller 20 and the second controller 30.

Further, according to the exemplary embodiment of the present disclosure, the apparatus for performing the virtual effect generation process may include an interface 11. The interface 11 is provided such that the driver is able to input either ON or OFF of a function of generating the virtual effect, wherein the function includes a function of outputting the virtual sound and a function of producing the virtual vibration.

In an exemplary embodiment of the present disclosure, as the interface 11, any means may be used enabling a driver in an electric vehicle to manipulate ON and OFF of the function of generating the virtual effect. For example, the interface 11 may be a manipulation device, such as a button, a switch, etc., provided in an electric vehicle, or may be an input device of an audio, video, navigation (AVN) system, a touch screen, etc.

The interface 11 may be connected to the first controller 20. Accordingly, when the driver inputs ON or OFF manipulation through the interface 11, an on signal or an off signal from the interface 11 is input to the first controller 20. In other words, the first controller 20 may be configured to recognize the ON or OFF manipulation state, input from the driver, of the function of generating the virtual effect.

In the present disclosure, the function of generating the virtual effect during driving of the electric vehicle, specifically, the function of outputting the virtual sound by using the sound device including the sound generator 51, the amplifier 52, and the speaker 53, and the function of producing the virtual vibration by using the at least one vibration actuator 100, may be performed only when the driver inputs ON through the interface 11.

In addition, in a case in which the interface 11 is an input device for the electric vehicle provided therein, the driver is able to manipulate ON and OFF of the function of generating the virtual effect, through a mobile device as another example of the interface. The mobile device needs to be communicatively connected to an in-vehicle device, for example, the first controller 20. Accordingly, an input/output communication interface for communication connection between the mobile device and the first controller 20 is used.

The driving information detector 12 may be configured to detect the vehicle driving information required for generating the torque command in the electric vehicle as well as vehicle driving information (driving variable information) required for performing the functions of outputting the virtual sound and producing the virtual vibration. In an exemplary embodiment of the present disclosure, the driving information detector 12 may be configured to detect the vehicle driving information for generating the virtual effect producing signal. The driving information detector 12 may include one of the following: an accelerator pedal detector configured to detect accelerator pedal input information (the accelerator pedal input value) depending on the driver's manipulation of the accelerator pedal; and a speed detector configured to detect the powertrain speed of the electric vehicle.

Herein, the accelerator pedal detector may be a common accelerator position sensor (APS) that is disposed at the accelerator pedal and outputs an electrical signal according to the state of the accelerator pedal manipulated by the driver. In addition, the speed detector may be configured to acquire information on the powertrain speed of the electric vehicle. The powertrain speed may be a rotational speed (motor speed) of a motor, i.e., a driving motor 41, driving the electric vehicle, a rotational speed (driving wheel speed) of a driving wheel 43, or a rotational speed (drive shaft speed) of a drive shaft. Herein, the speed detector may be a resolver disposed at the driving motor 41, a wheel speed sensor placed at the driving wheel 43, or a sensor sensing the drive shaft speed.

In addition, in the present disclosure, the vehicle driving information may be used in generating the torque command and the virtual effect producing signal, and may include a vehicle speed. In particular, the driving information detector 12 may include a vehicle speed detector configured to detect a current driving vehicle speed, and the vehicle speed detector may include the wheel speed sensor disposed at the driving wheel 43 of the electric vehicle.

In addition, the first controller 20 may be configured to determine and generate a torque command based on the vehicle driving information. Further, the first controller 20 may be configured to determine characteristics of a virtual effect based on the vehicle driving information or of the vehicle driving information and virtual variable information, and generate and output a virtual effect producing signal according to the determined characteristics of the virtual effect. Herein, the virtual variable information may be a virtual engine speed, a virtual vehicle speed, a virtual gear position, or the like.

The torque command may be a motor torque command that is determined and generated on the basis of the vehicle driving information collected during driving of a common electric vehicle. The first controller 20 may be a vehicle control unit (VCU) configured to generate the motor torque command based on the vehicle driving information in a common electric vehicle.

The second controller 30 may be a controller configured to receive the torque command transmitted from the first controller 20 and operate the driving device 41. In the present disclosure, the driving device 41 is a motor, i.e., the driving motor 41, connected to the driving wheel 43 of the electric vehicle and driving the electric vehicle. The second controller 30 may be a known motor control unit (MCU) configured to operate the motor 41 through an inverter in a common electric vehicle and adjust the driving of the motor 41.

In FIG. 3, the torque that the motor, which is the driving device 41, outputs is reduced by a reducer 42 and the resulting torque is transmitted to the driving wheel 43. In FIG. 3, reference numeral 54 denotes a cluster placed in front of the driver seat of the electric vehicle. Through the cluster 54, a current vehicle speed, a current virtual engine speed, a virtual gear position, etc. may be displayed.

In the present disclosure, the virtual effect producing signal used for producing and outputting the virtual sound and the virtual vibration may be a signal matched to the characteristics of the virtual sound and the virtual vibration in conjunction therewith under a current vehicle driving condition. As described above, when the controller generates and outputs the virtual effect producing signal matched to the characteristics of the virtual sound based on the vehicle driving information, the sound device outputs desired virtual sound by using the sound source signal and the virtual effect producing signal. In addition, the vibration actuator 100 may be configured to output the virtual vibration in conjunction with the virtual sound by using the virtual effect producing signal.

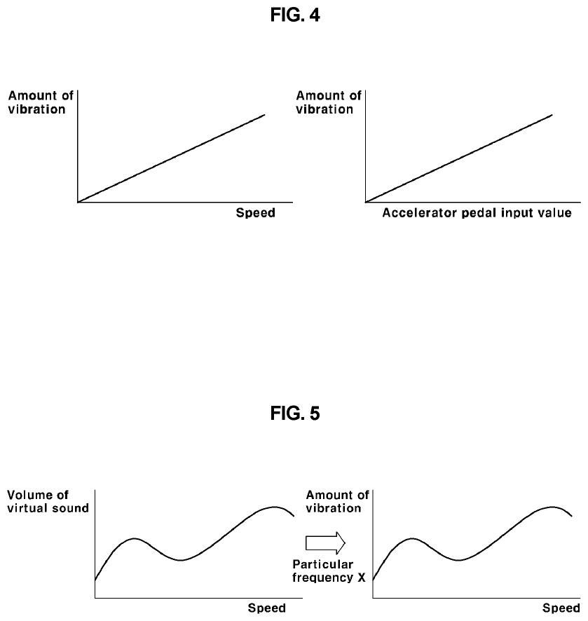

FIGS. 4 and 5 are diagrams showing examples of controlling the virtual vibration and the virtual sound according to an embodiment of the present disclosure. FIG. 4 shows an example of a pattern of the virtual vibration in constant-speed driving, and FIG. 5 shows an example of a pattern of the virtual vibration determined in conjunction with the virtual sound in acceleration driving.

In the examples of FIGS. 4 and 5, the speed is the above-described powertrain speed that may be the actual variable of the electric vehicle, such as the motor speed, the driving wheel speed, or the drive shaft speed, or is the actual vehicle speed. Alternatively, the speed may be the virtual engine speed or the virtual vehicle speed that are the virtual variables of the electric vehicle. Further, in FIG. 4, the speed and the accelerator pedal input value (APS value) may be replaced with a motor torque command.

In the present disclosure, the characteristics of the virtual effect are characteristics of the vibration to be produced through the vibration actuators and characteristics of the virtual sound to be produced through the sound device. The characteristics may include the amount of vibration and the volume of the virtual sound determined according to the vehicle driving information (actual variable or virtual variable). More specifically, the characteristics of the virtual effect may include the amount of vibration and the volume of the virtual sound according to the accelerator pedal input value, the powertrain speed, or the motor torque command that are the vehicle driving information.

Herein, the amount of vibration may be replaced with the amplitude, and the characteristics of the virtual effect for producing the virtual vibration may include the amplitude and the period of the vibration, and the frequency band. In addition, the volume of the virtual sound refers to the strength of the sound, and the characteristics of the virtual effect for producing the virtual sound may include the strength and the time interval (the time interval of the sound) of the virtual sound, and the frequency band or the pitch (high or low of the sound).

For example, the characteristics of the virtual effect may include at least one or two among the amount of vibration, the amplitude, the period, and the frequency band of the vibration to be produced through the vibration actuators for providing the virtual vibration, and may include the strength and the time interval, and the frequency band or the pitch (high or low of the sound) of the virtual sound to be produced through the sound device for providing the virtual sound.

As shown in FIG. 4, the amount of vibration may be determined to a value linearly proportional to the accelerator pedal input value and the powertrain speed. In other words, the greater the accelerator pedal input value and the powertrain speed, the greater the amount of vibration. Further, when the amount of vibration is determined using the real-time actual variable information or the virtual variable information, the controller may be configured to generate and output the virtual effect producing signal for producing vibration matched to the determined amount of vibration so that operation of the vibration actuators is controlled according to the virtual effect producing signal.

In addition, as shown in FIG. 5, when the volume that is the characteristic of the virtual sound according to the speed is determined, the amount of vibration that is the characteristic of the virtual vibration is determined in the same pattern according to the speed, whereby the virtual vibration in conjunction with the virtual sound is produced. Through this, the virtual sound and the virtual vibration may be produced simultaneously.

As described above, in the present disclosure, the controller may be configured to determine the characteristics of the virtual vibration from the characteristics of the virtual sound among the characteristics of the virtual effect, and then generate the virtual effect producing signal according to the determined characteristics of the virtual vibration. For example, as shown in FIG. 5, the volume of the virtual sound may be converted into the amount of virtual vibration.

Alternatively, when the virtual sound is output through the speaker in the interior of the electric vehicle, the virtual sound in the interior of the electric vehicle is sensed using a sensor. Next, the controller may be configured to process a signal of the sensed virtual sound to convert the signal into a signal of vibration, and using the resulting signal of vibration as the virtual effect producing signal for producing vibration, the controller may be configured to operate the vibration actuators to produce the virtual vibration.

Herein, the sensor may be a microphone capable of inputting and sensing sound. Further, the producing of the virtual vibration through the vibration actuators by using a signal (as the virtual effect producing signal) of the virtual vibration generated by converting the signal of the sensed virtual sound may be performed in the same manner as the producing of the virtual vibration through the vibration actuators by using the virtual effect producing signal, as described above.

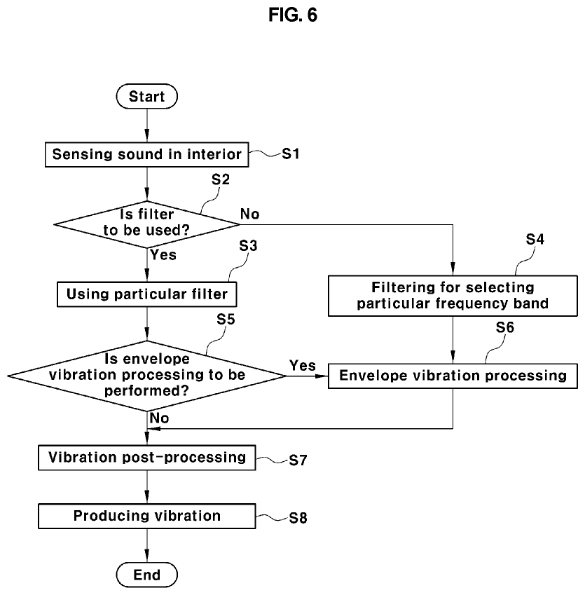

FIG. 6 is a flowchart showing a process of producing virtual vibration based on virtual sound by converting a signal of virtual sound sensed during acceleration driving into a signal of virtual vibration in a method of generating a virtual effect according to an exemplary embodiment of the present disclosure. To convert the signal of the virtual sound sensed in the interior of the electric vehicle to perform processing for virtual vibration, the controller may use the volume of the virtual sound of information on the characteristics of the virtual sound.

In other words the signal of the virtual sound may be a signal including information on the volume of the virtual sound that is output through the sound device according to the vehicle driving information. Herein, the controller may be configured to convert the signal of the virtual sound indicating the volume of the virtual sound sensed through the sensor, into the signal of the virtual vibration.

The control process of FIG. 6 is continuously performed while the virtual sound is output in the interior of the electric vehicle during driving. First, the virtual sound in the interior of the electric vehicle is sensed through the sensor at step S1, and the controller may be configured to process a signal of the virtual sound including information on the volume of the sensed virtual sound. Herein, sound signals of left and right channels resulting from sensing of the virtual sound with the respective sensors after output from the sound device may be synthesized and the synthesized sound signals may be used. This is to prevent signal loss due to stereo effect.

For example, if sound having the effect of putting low tones on the left channel and the high tones on the right channel is output through the speaker in the interior of the electric vehicle, when the right channel is used, low-tone vibration is generated because a signal for the low tones is unable to be sensed. To prevent this, the sound signals of the left and the right channel are synthesized for use.

When the virtual sound is sensed in the interior of the electric vehicle, the sensed virtual sound may be filtered so that a signal of the virtual sound in a frequency band corresponding to low or high tones is selected at steps S2 and S3. For example, a low-tone part may be selected using a low-tone filter or a high-tone part may be selected using a high-tone filter. Alternatively, other than low or high tones as described above, a particular frequency band may be selected. In other words, a filter capable of passing a determined frequency band of the virtual sound is used so that the determined frequency band is selected and processed at step S4.

In addition, when the vibration actuators produce vibration based on a signal corresponding to sound other that low tones, the result is heard as sound rather than felt as vibration. To prevent this, envelope processing may be performed on the signal of the virtual sound at steps S5 and S6. The envelope processing is logic that generates a frequency equal to the size of an input waveform, and may generate a low-tone frequency regardless of a high-frequency waveform. For example, when a signal in a particular high-frequency region is filtered and subjected to envelope processing, vibration that substantially matches the sound is produced.

Herein, envelope processing may be performed on a signal in which a low-tone part is selected using a low-tone filter, and when using envelope processing, vibration that substantially matches the sound is realized. Last, vibration post-processing may be performed using the filtered and envelope-processed signal at step S7, and by using the final signal, the vibration actuators may be operated to produce vibration at step S8. As for the process of envelope processing of a sound signal, the method, etc. is well known technology to those skilled in the art, and thus a detailed description thereof will be omitted.

Although an exemplary embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A method of generating a virtual effect for an electric vehicle, comprising:
collecting, by a controller, vehicle driving information for generating the virtual effect during driving of the electric vehicle;
determining, by the controller, a characteristic of the virtual effect based on the collected vehicle driving information;
generating, by the controller, a virtual effect producing signal for producing the determined characteristic of the virtual effect; and
operating, by the virtual effect producing signal generated by the controller, a vibration actuator disposed in a seat of the electric vehicle such that the vibration actuator produces vibration according to the determined characteristic of the virtual effect and a driver or a passenger who is in the seat experiences the vibration.

2. The method of claim 1, wherein the vehicle driving information includes one among a driver accelerator pedal input value detected by an accelerator pedal detector, a vehicle powertrain speed detected by a speed detector, and a vehicle speed detected by a vehicle speed detector.

3. The method of claim 2, wherein the vehicle powertrain speed is one among a rotational speed of a vehicle driving motor, a rotational speed of a driving wheel, and a rotational speed of a drive shaft.

4. The method of claim 1, wherein the controller is configured to determine the characteristic of the virtual effect from a torque command of a vehicle driving motor acquired by the collected vehicle driving information.

5. The method of claim 1, wherein the characteristic of the virtual effect includes at least one among an amount, an amplitude, a period, and a frequency band of the vibration to be produced by the vibration actuator.

6. The method of claim 5, wherein the vehicle driving information includes one among a driver accelerator pedal input value detected by an accelerator pedal detector, a vehicle powertrain speed detected by a speed detector, and a vehicle speed detected by a vehicle speed detector, and the controller is configured to determine the amount of the vibration to be a value that is proportional to the driver accelerator pedal input value, the vehicle powertrain speed, or the vehicle speed.

7. The method of claim 1, further comprising:
operating, by the virtual effect producing signal generated by the controller, a sound device provided at the electric vehicle such that the sound device produces virtual sound according to the determined characteristic of the virtual effect.

8. The method of claim 7, wherein the virtual sound is virtual post-combustion sound simulating post-combustion sound coming from an exhaust system of an internal combustion engine vehicle, virtual engine sound simulating engine sound coming from an engine of the internal combustion engine vehicle, or virtual motor sound that is imagined coming from a vehicle driving motor.

9. The method of claim 7, wherein the characteristic of the virtual effect for producing the virtual sound includes a starting point in time at which the virtual sound is output through the sound device, and further includes at least one among a strength, duration, a time interval of the virtual sound, and a frequency band or a pitch that is how high or low a sound is.

10. The method of claim 7, wherein the virtual effect is the virtual sound and virtual vibration, and the controller is configured to,
determine a characteristic of the virtual sound for producing the virtual sound,
determine, from the determined characteristic of the virtual sound, a characteristic of the virtual vibration for producing the virtual vibration, and
generate the virtual effect producing signal according to the determined characteristic of the virtual sound and the determined characteristic of the virtual vibration, so that the vibration actuator produces the virtual vibration and the sound device produces the virtual sound simultaneously according to the generated virtual effect producing signal.

11. The method of claim 7, wherein when the virtual sound is produced in an interior of the electric vehicle through the sound device, the produced virtual sound is sensed through a sensor, the controller is configured to convert a signal of the sensed virtual sound into a signal of vibration, and the controller uses the signal of vibration resulting from conversion as the virtual effect producing signal for producing virtual vibration so that the vibration actuator produces the virtual vibration.

12. The method of claim 11, wherein the controller is configured to synthetize a signal of the virtual sound of a left channel and a signal of the virtual sound of a right channel that are sensed by the respective sensors after output from the sound device, and convert the synthesized signals of the virtual sound into the signal of vibration.

13. The method of claim 11, wherein the controller causes a filter to filter the signal of the sensed virtual sound such that from the signal of the sensed virtual sound, a frequency band corresponding to a low tone or a high tone is selected or a determined frequency band is selected, and the controller converts the resulting signal into the signal of vibration.

14. The method of claim 13, wherein the filtered signal of the virtual sound is subjected to envelope processing and is converted into the signal of vibration.
